(19) United States
(12) Patent Application Publication
(10) Pub. No.: US 2023/0055831 A1
(43) Pub. Date: Feb. 23, 2023

(54) SPRING COMPRESSION ARRANGEMENT FOR A BED MATTRESS

(71) Applicant: MODILECT AB, Uppsala (SE)

(72) Inventor: John Wahlgren, Uppsala (SE)

(21) Appl. No.: 17/796,207

(22) PCT Filed: Jan. 28, 2021
(86) PCT No.: PCT/SE2021/050056

§ 371 Date: Jul. 28, 2022

(30) Foreign Application Priority Data
Jan. 30, 2020 (SE) 2050087-2

(51) Int. Cl. A47C 27/20; A47C 27/06

(52) U.S. Cl. CPC A47C 27/20; A47C 27/061

(57) ABSTRACT

The proposed technology provides a spring compression arrangement (100) for a bed mattress (11). The spring compression arrangement (1) comprises a block (1) made of an elastic material, where the block comprises a first outer surface (12a) and an oppositely positioned, second outer surface (12b), the spring compression arrangement (1) further comprises a plurality of springs (2) provided in said block (1), said springs extending in a direction from said second outer surface (12b) to said first outer surface (12a). The proposed technology also provides a bed mattress comprising such a spring compression arrangement as well as a bed comprising bed mattress comprising such a spring compression arrangement. Also disclosed is a method for producing a spring compression arrangement according to the proposed technology.

### TECHNICAL FIELD

The proposed technology generally relates to a spring compression arrangement for a bed mattress as well as a bed mattress and a bed comprising such a compression arrangement.

### BACKGROUND

There are a number of different mechanisms within the bed technology to obtain bed mattresses with adjustable firmness or compression levels. A relatively common mechanism is to utilize motors that apply forces on one, or several, compression planes in the bed to thereby create a variable tension in the springs that are arranged on or above such a compression plane. If the motor presses the compression plane in an upward direction, the springs will, as a consequence, be compressed, which leads to one type of firmness in the mattress, while an adjustment of the compression plane in the downward direction yields less compressed springs leading to another type of firmness in the mattress. Even if these known constructions enable an adjustable bed firmness, they contain a lot of mechanical components. This make the bed hard to construct and assemble. Some of the components used are also quite delicate and thus easily damaged, something that will require repairments or replacements. This can however be quite cumbersome since the components are hard to reach. It is thus a continuous need within the art to design bed mattresses that have an adjustable firmness but also overcome some of the problems within the field. The proposed technology aims to provide bed mattress arrangement that at least alleviates some of the problem within the field.

### SUMMARY

It is an object to provide a spring compression arrangement for a bed mattress that is easy to assemble and that provides a robust spring construction.

It is another object to provide a bed mattress that comprises such a spring compression arrangement.

It is still another object to provide a bed that comprises a bed mattress comprising such a spring compression arrangement.

These and other objects are met by embodiments of the proposed technology.

According to a first aspect, there is provided a spring compression arrangement for a bed mattress. The spring compression arrangement comprises a block made of an elastic material, the block comprising a first outer surface and an oppositely positioned, second outer surface. The block comprises through holes extending between the first and second outer surface. The arrangement also comprises a plurality of springs provided in the through holes in the block, the springs extending in a direction from the second outer surface to the first outer surface.

According to a second aspect there is also provided a bed mattress comprising a frame and a spring compression arrangement according to the first aspect that is attached to the frame.

According to a third aspect there is provided a bed comprising a bed mattress according to the second aspect.

According to a fourth aspect there is provided a method for manufacturing a spring compression arrangement for a bed mattress. The method comprises the step of providing a block of an elastic material. The block comprising a first outer surface and a second, oppositely arranged, outer surface. A number of through holes are created, thereby extending through the block. The method also comprises to arrange a plurality of springs in the through holes in the block so that the springs extend in a direction from the second outer surface to the first outer surface.

The proposed technology enables bed mattresses and beds with adjustable firmness that are also robust and easy to assemble. The fact that the bed mattresses are easy to assemble enables in turn a time economical assemblage and installation of the bed. Other advantages will be appreciated when reading the detailed description.

### BRIEF DESCRIPTION OF THE DRAWINGS

The embodiments, together with further objects and advantages thereof, may best be understood by making reference to the following description taken together with the accompanying drawings, in which:

FIG. 1a is a schematic view of a spring arrangement in an elastic material block.

FIG. 1b is a schematic view of the exterior surfaces of the elastic material of FIG. 1a.

FIG. 2a is a schematic view of a spring compression arrangement for a bed mattress according to the proposed technology, comprising a configuration of springs contained in an elastic material block.

FIG. 2b is a perspective view of the spring compression arrangement for a bed mattress illustrated in FIG. 2a.

FIG. 3a is a schematic view of a spring compression arrangement for a bed mattress according to FIG. 2a but where the spring compression arrangement also comprises a plane and a number of wires or cords that are adapted to alter the compression level of the mattress.

FIG. 3b is a perspective view of the spring compression arrangement for a bed mattress shown in FIG. 3a.

FIG. 4 is a side view of spring compression arrangement according to the proposed technology when it is arranged in a bed mattress.

FIG. 5 is a schematic view of a spring compression arrangement for a bed mattress where the springs are given a configuration so that they protrude above an upper surface of the elastic material block.

### DETAILED DESCRIPTION

Throughout the drawings, the same reference designations are used for similar or corresponding elements.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Any direction references, such as e.g. “upper”, “top”, “lower” or “above”, refer to the arrangements when placed in an intended direction of use. In other words, such terms are defined as when the bed mattress is positioned for supporting a body. These directions are also illustrated in the figures.

For a better understanding of the proposed technology, it may be useful to begin with a brief discussion of the problems associated with bed mattresses having adjustable firmness. To this end consider the case with a bed mattress comprising springs embedded in textile pockets. In their natural and unstretched state these springs provide a natural compression level, referred to as a ground state level. In order to change the ground state level, the springs have to be compressed. One particular way to achieve such a compression is to provide the bed mattress with spring compression means that will act on the springs in order to compress the strings. This may for example be achieved by attaching strings or cords to one end, i.e., the upper end in a vertical direction, of the springs embedded in the textile pocket and attaching the other end to a movable plane arranged below the springs. By raising or lowering the movable plane it will be possible to alter the length of the springs and thus to alter the compression level of the mattress. A clear disadvantage with this construction is that all the springs are embedded in the textile cover referred to as a textile pocket. This leads to a highly complicated procedure for attaching individual strings or cords to the springs. The individual textile pockets are also rather delicate, and they may get ripped if they become entangled with the springs when the latter are in a low compressed state. A ripped hole in a textile pocket may in turn lead to lose or free textile edges, which in turn can be intertwined with the springs and negatively affect the ability to compress the spring. If the springs are unevenly compressed it will result in an unbalanced compression of the bed mattress, and thus a less comfortable bed mattress. The proposed technology aims to at least partially overcome the problem associated with this type of bed arrangement.

To this end, a spring compression arrangement 100 for a bed mattress 11 comprises a block 1 made of an elastic material, the block comprises a first outer surface 12a and an oppositely positioned, second outer surface 12b. The spring compression arrangement 1 also comprises a plurality of springs 2 provided in the block 1, the springs extending in a direction from the second outer surface 12b to the first outer surface 12a.

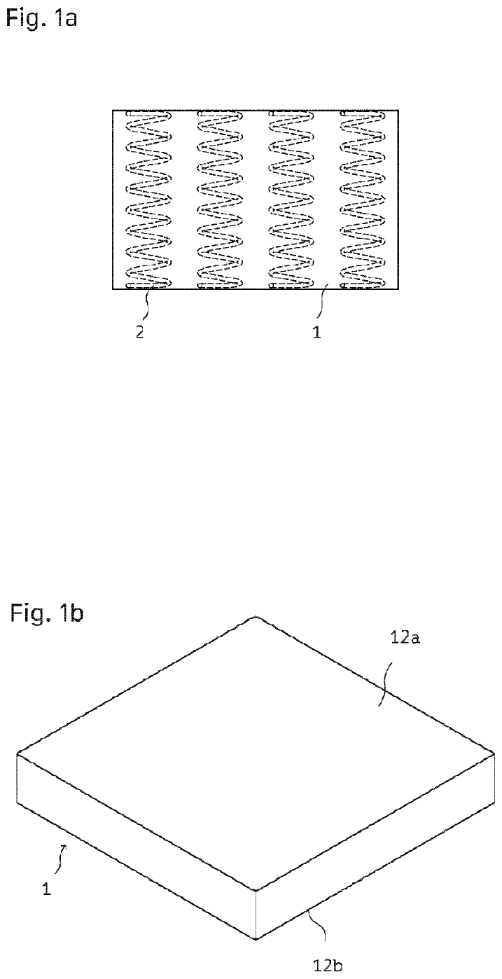

The above specified arrangement provides a bed mattress compression mechanism that is very robust and easy to install. The arrangement is schematically illustrated in FIG. 1a and FIG. 1b. The spring compression arrangement comprises a block made of an elastic material, such as a foam, that is, a material matrix containing bubbles/cells that are at least partially open, thus rendering a matrix through which air can redistribute. The block is preferably shaped as a rectangular box of an elastic material. The block material is preferably selected from the group comprising of different foams, in particular foams of polyurethane, latex, memory foam, gel foam or foams having the same elasticity characteristics as one or more of those. The elastic material may also be a combination of foams as above. The elastic characteristics of the material allows for an alteration of the hardness or compactness of the block and this feature can be used to alter the compression level of the block and thus the mattress containing the spring compression arrangement. The spring compression arrangement also comprises a number of springs that are provided in the elastic material block. The provision of springs in the elastic material block is shown in FIG. 1 a. During use of the spring compression arrangement in a mattress the springs will be arranged in a first direction, e.g. a vertical direction. The provision of springs in the elastic material block provides one additional degree of freedom for altering the compression level of a mattress, that is, the spring compression level can be based on both the compression level provided by the material in the block and the level of compression that is achieved by the tension in the springs. The latter may be used to tune the overall compression level obtained by the material in the block. Examples of how the tuning of the compression level may be obtained will be described in what follows. The proposed spring compression arrangement for a bed mattress as disclosed herein have several advantages beside the ones already mentioned. A first advantage obtained by utilizing an elastic material block together with springs is that the elastic material block stabilizes the springs. The fact that the springs are more stably arranged in the block, as compared to a textile pocket, enables a larger freedom when positioning the springs in the block. It also enables the usage of a larger selection of springs. The combination of an elastic material block and springs also yields a more pronounced difference between hard and soft spots on the mattress.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

According to an embodiment of the proposed technology there is provided a spring compression arrangement 100 wherein the block 1 comprises through holes 3, each of the through holes extending between the first outer surface 12a and the second outer surface 12b and wherein each of the springs are provided in a corresponding through hole 3.

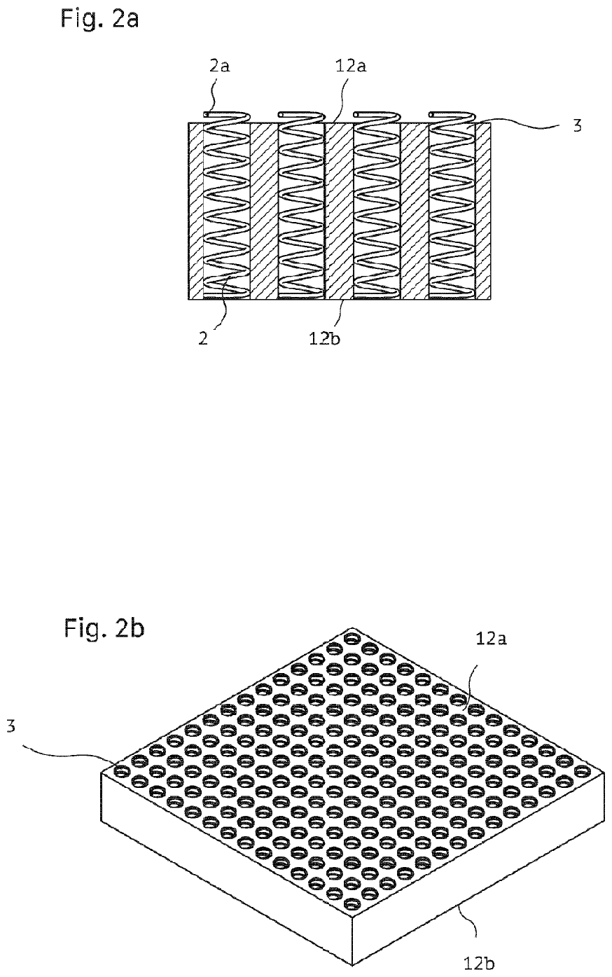

The springs are here allowed to move along the direction of their corresponding through-hole 3 provided in the block. FIG. 2a provides a cross-sectional view of this embodiment illustrating that each of the springs 2 are provided in through-holes 3 arranged in the elastic material block.

According to another embodiment of the proposed technology there is provided a spring compression arrangement 100, wherein one end 2a of at least a subset of the springs 2 protrudes a distance D above the first outer surface 12a of the block 1. This embodiment is also shown in FIG. 2a.

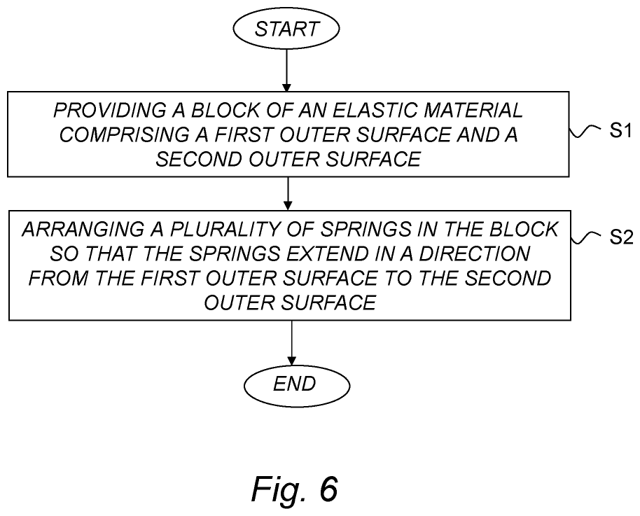

According to a specific version of the above embodiment there is provided a spring compression arrangement 100 wherein the distance D is selected from the interval [H/100; H/2], where H is the height in the direction from the second outer surface 12b to the first outer surface 12a of the elastic material block 1. FIG. 5 illustrates how the springs extend a distance D above the surface 12a of the elastic material block 1.

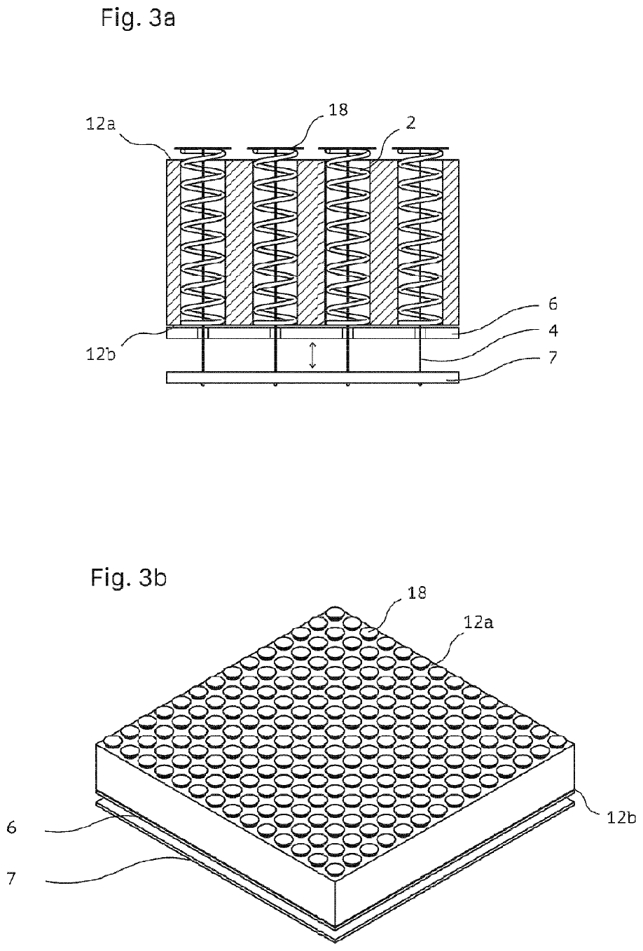

In an embodiment as illustrated by FIG. 3a, a spring compression arrangement 100 wherein the outermost end of the springs 2 are attached to a wire 4. The outermost end of the springs is the upper end situated closest to the first outer surface 12a.

In a particular embodiment, the outermost end of the springs 2 are provided with a cap 18 having a hook or a hole that enables fastening of the wire 4 to the cap 18. This embodiment is illustrated in FIG. 3a.

A particular embodiment of the proposed technology provides a spring compression arrangement 100, wherein the arrangement further comprises a first plane 7 attached to the block 1, the first plane 7 running essentially parallel with the second outer surface 12b. The arrangement also comprises wires 4 extending between a corresponding cap 18 and the first plane 7, the cords or wires 4 having one end attached to the corresponding cap 18 and one end attached to the first plane 7. The arrangement also comprises a second plane 6 movably arranged between the second outer surface 12b on block 1 and the first plane 7, the second plane comprising a number of holes that enables the wires 4 to run through the second plane 6. The arrangement further comprises a lifting device 8 connected to the second plane 6 and being configured to raise or lower the position of the second plane relative 6 the first plane 7 thereby altering the level of compression of the elastic material block 1 and the springs 2. The second plane 6 is arranged so as to be movable relative the fixated first plane 7. The second plane 6 should preferably be arranged so as to lie flush with the second outer surface 12b, that is to say, the second outer surface 12b may preferably rest on the second plane 6. When the second plane 6 is lifted this would automatically ensure that the second outer surface 12b, as well as the spring ends closest thereto are pressed upwards ensuring a change in the compression level of both the elastic material block 1 and the springs 2.

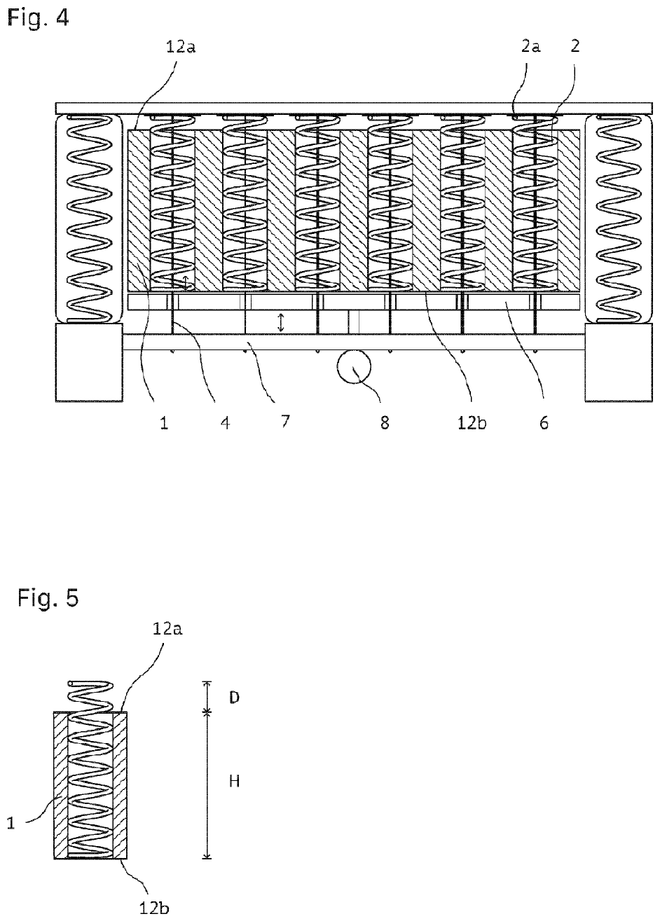

This embodiment provides a specific spring compression arrangement that is illustrated as embedded in a mattress in FIG. 4. This compression arrangement comprises a block 1 created as an elastic material matrix, preferably as a box shaped matrix of elastic material. The matrix comprises in turn a number of through-holes extending from a first, e.g., upper, surface 12a to a second, e.g., lower, surface 12b. Each of the through-holes contains a spring 2 having an upper end that is preferably, though not necessarily, extending above the surface 12a. An upper end 2a of the springs comprises a cap 18 provided with a hook or a hole. A wire 4 is at one end attached to the cap 18 using the hook or the hole. The other end of the wire is attached to the first plane 7. A second plane 6 is arranged between the second outer surface 12b on block 1 and the first plane 7 in such a way that it is allowed to move in a direction extending between the first plane and the outer surface 12b on block 1, i.e., in the vertical direction in FIG. 4. The second plane 7 is provided with a number of holes that enables the wires 4 to run through the second plane 6 in order to be attached to the first plane 7.

A particular version of the embodiment described with reference to FIG. 4 provides a spring compression arrangement 100 wherein the lifting device 8 comprises an electrically or hydraulically driven lift able to continually raise or lower the position of the second plane 6 relative the first plane 7.

Having described in detail the components comprised in the spring compression arrangement of FIG. 4, we will not proceed and describe how it can be used to alter the compression level in a bed mattress. For this purpose, consider the spring compression arrangement disclosed in FIG. 4. In the configuration with the lowest compression level, the second plane 6 lies essentially flush with the first plane 7, preferably it also lies flush with the lower surface 12b of the block 1. To alter this compression level, i.e., to increase the compression, the lifting device 8 is initiated. The lifting device 8 acts to raise the movable second plane 6 above the surface of the first plane 7. Since the top end 2a of the springs are attached to the first plane 7, the top end 2a keeps it vertical position relative the first plane 7. The movement of the movable plane 6 presses the lower end of the springs as well as the surface 12b on the block vertically upwards. The fact that the springs 2 and the block 1 is looked to the first plane 7 through the wires or cords 4, the lifting action will cause the springs and the block to be pressed together, thus altering, i.e. raising, the compression level of the bed mattress comprising the spring compression arrangement. This action can also be reversed so as to lower the compression level of the spring and block arrangement by allowing the lifting device to lower the position of the second plane 6 towards the position of the first plane 7.

Still another embodiment of the proposed technology provides a spring compression arrangement 100 wherein the springs 2 comprises coil springs or helical springs.

The proposed technology also provides a bed mattress equipped with a spring compression arrangement as described. To this end there is provided a bed mattress 11 that comprises a frame 50 and a spring compression arrangement 100 according to what has been described earlier that is connected to the frame 50.

The proposed technology also provides a bed 1000 that comprises a bed mattress equipped with a spring compression arrangement according to what has been described earlier.

In addition to the devices described earlier, the proposed technology also provides a method for producing a spring compression arrangement for a bed mattress. To this end it is disclosed a method for manufacturing a spring compression arrangement 1 for a bed mattress 5. The method comprising the step of providing 51 a block 1 of an elastic material, the block comprising a first outer surface 12a and a second, oppositely arranged, outer surface 12b. The method also comprises the step of arranging S2 a plurality of springs 2 in the block 1 so that said springs extend in a direction from the second outer surface 12b to the first outer surface 12a. FIG. 6 is a schematic flow diagram illustrating the proposed method.

The proposed technology provides a method for producing a block of elastic material where springs are arranged in through-holes provided in the block. To this end there is disclosed a method wherein the step of providing a block 1 further comprises to create a number of through holes extending through the block 1 of elastic material, i.e. extending from the first outer surface 12a to the second, oppositely arranged, outer surface 12b, and wherein the step of arranging S2 a plurality of springs 2 in the block 1 comprises to arrange a spring 2 in at least some of the created through holes. The through-holes are preferably created by performing water cutting, sometimes referred to as water jet cutting, on the block 1 of elastic material, that is, by using a water jet as the cutting tool for creating through-holes in the block 1.

A particular embodiment of the proposed technology provides a method that further comprises the step of attaching a wire 4 to an upper end of each spring. The wire has a length that is longer than the distance between the first outer surface 12a and the second, oppositely arranged, outer surface 12b.

In a further preferred embodiment, the method further comprises providing an end of each of spring 2 with a cap 18 comprising a hook or a hole. Thereby the attaching of the wire to the upper end of the springs is performed to the cap by utilizing the hook or hole.;

This embodiment provides a version of the elastic material block 1 that can be used in a spring compression arrangement as shown in FIG. 4. To arrive at this spring compression arrangement the method can be supplemented by having the following steps.
providing a second plane 6 below the second outer surface 12b on block 1,
creating a number of holes in said second plane to enables the wires 4 to run through the second plane 6;
attaching a first plane 7 to the block 1 below the second plane 6, so that the first plane 7 runs essentially parallel with the second outer surface 12b of the block;
attaching the open ends on the wires 4 to the first plane 7, by first threading them through the holes created in the second plane; and
connecting a lifting device 8 to the second plane 6 to enable the lifting device to raise or lower the position of the second plane 6 relative the first plane 7.

1. A spring compression arrangement for a bed mattress, said spring compression arrangement comprising:
a block made of an elastic material, said block comprising a first outer surface and an oppositely positioned, second outer surface; and
a plurality of springs;
said block comprises through holes, each of said through holes extending between said first outer surface and said second outer surface; and
said plurality of springs being provided in a corresponding through hole in said block, said springs extending in a direction from said second outer surface to said first outer surface,
a first plane running essentially parallel with said second outer surface;
wires having one end attached to said first plane and an opposite end attached to an upper end, closest to said first outer surface, of a respective spring;
a second plane movably arranged between said second outer surface on block and said first plane, said second plane comprising a number of holes, through which said wires are provided.

2. The spring compression arrangement according to claim 1, wherein said upper end of each spring is provided with a cap to which a respective one of said wires is attached.

3. The spring compression arrangement according to claim 2, wherein said cap has a hook or a hole that enables fastening said wire to said cap.

4. The spring compression arrangement according to any of the claim 1, further comprising:
a lifting device connected to said second plane and being configured to raise or lower the position of said second plane relative said first plane thereby altering the level of compression of said elastic material block and said springs.

5. The spring compression arrangement according to claim 4, wherein said lifting device comprises an electrically or hydraulically driven lift able to continually raise or lower the position of said second plane relative said first plane.

6. The spring compression arrangement, according to claim 1, wherein said upper end of at least a subset of said springs protrudes a distance D above said first outer surface of said block.

7. The spring compression arrangement, according to claim 6, wherein said distance D is selected from the interval [H/100; H/2], where H is the height in the direction from said second outer surface to said first outer surface of said block.

8. The spring compression arrangement, according to any of the claim 1, wherein said springs comprise coil springs or helical springs.

9. Abed mattress comprising:
a frame; and
a spring compression arrangement according to any of the claim connected to said frame.

10. A bed comprising a bed mattress according to claim 9.

11. A method for manufacturing a spring compression arrangement for a bed mattress, said method comprising the steps of:
providing a block of an elastic material, said block comprising a first outer surface and a second, oppositely arranged, outer surface;
creating a number of through holes extending through said block of elastic material; and
arranging a plurality of springs in at least in some of said through holes in said block so that said springs extend in a direction from said second outer surface to said first outer surface;
attaching a wire to an upper end, closest to said first outer surface, each of said springs, said wire having a length that is longer than the distance between said first outer surface and said second, oppositely arranged, outer surface.

12. The method according to claim 11, comprising the further step of:
providing an end of each of said springs with a cap comprising a hook or a hole, whereby said attaching of said wire to said upper end of said springs is performed to said cap by utilizing said hook or hole.

13. The spring compression arrangement according to claim 2, further comprising:
a lifting device connected to said second plane and being configured to raise or lower the position of said second plane relative said first plane thereby altering the level of compression of said elastic material block and said springs.

14. The spring compression arrangement according to claim 3, further comprising:
a lifting device connected to said second plane and being configured to raise or lower the position of said second plane relative said first plane thereby altering the level of compression of said elastic material block and said springs.

15. The spring compression arrangement according to claim 13, wherein said lifting device comprises an electrically or hydraulically driven lift able to continually raise or lower the position of said second plane relative said first plane.

16. The spring compression arrangement according to claim 14, wherein said lifting device comprises an electrically or hydraulically driven lift able to continually raise or lower the position of said second plane relative said first plane.

17. The bed mattress according to claim 9, wherein said upper end of each spring is provided with a cap to which a respective one of said wires is attached.

18. The bed mattress according to claim 17, wherein said cap has a hook or a hole that enables fastening said wire to said cap.

19. The bed according to claim 10, wherein said upper end of each spring is provided with a cap to which a respective one of said wires is attached.

20. The bed according to claim 19, wherein said cap has a hook or a hole that enables fastening said wire to said cap.
